(19) United States
(12) Patent Application Publication
(10) Pub. No.: US 2013/0244006 A1
(43) Pub. Date: Sep. 19, 2013

(54) Optimal sandwich core structures and forming tools for the mass production of sandwich structures

(71) Applicant: Fabien Ebnoether, Paris (FR)

(72) Inventor: Fabien Ebnoether, Paris (FR)

(21) Appl. No.: 13/419,613

(22) Filed: Mar. 14, 2012

(51) Int. Cl. B32B 3/28; B32B 15/01; B44B 5/00; B32B 3/30

(52) U.S. Cl. 428/166; 428/156; 428/172; 101/3.1

(57) ABSTRACT

A sandwich structure is provided that includes a corrugated layer with at least one core layer (structure) made of a periodic array of adjacent truncated upward facing peaks and truncated downward facing valleys. Each truncated peak has a bonding land of an area A1. Each truncated valley has a bonding land of an area A2. A ratio of A1/A2 is less than 2. A distance D is between neighboring peaks, and a distance D is also between neighboring valleys. The corrugated layer is made from an initially flat sheet thickness of t. A first sheet layer is physically coupled to bonding lands of the truncated peaks. A second sheet layer is physically coupled to bonding lands of the truncated valleys.

### FIELD OF THE INVENTION

The presented invention relates generally to structural/multifunctional material designs and methods for their manufacturing, and more specifically to sandwich core structures that are made from initially flat sheets and bonding techniques to form cellular solids with periodic microstructures.

### BACKGROUND OF THE INVENTION

Cellular solids are highly porous space filling materials with periodic or random microstructures. The effective properties of cellular solids are sensitive to the geometry of the underlying microstructures and the properties of the basis material from which these microstructures are made. In man-made cellular solids, the control of the microstructural geometry and the basis material properties is one of the key challenges in manufacturing. Foamed cellular solids typically feature a random microstructure of foam cells which is usually characterized through poor weight specific mechanical performance. For flat panel type of structures, cellular solids can be placed between two face sheets to form a sandwich panel. In particular, honeycomb sandwich panels are known for excellent bending stiffness to weight ratio. However, it appears to be impossible to manufacture metallic honeycombs in a cost-effective mass production process. Uni-directionally corrugated microstructures such as the core layer in cardboard can be produced very cost effectively. However, their weight specific mechanical performance is usually inferior to that of honeycombs. In particular, when used in metal sandwich construction, the bonding land between the core structure and the face sheets is often too small to transmit the full shear force through an adhesive bond. In other words, delamination between the core structure and the face sheets is often the critical failure mode. Furthermore, their mechanical properties are direction-dependent featuring a pronounced strong and weak direction when subject to transverse shear loading. In addition, the bonding land between a uni-directionally corrugated core structure and the face sheets is rather small and not well defined. Delamination is therefore a concern when using these materials for primary load carrying structures. It would thus be desirable to provide a technique for increasing the size of the bonding land without sacrificing weight specific mechanical performance. Uni-directionally corrugated core structures are the premier choice in applications such as packaging where costs are more important than strength and stiffness. It is apparent that it would be desirable to provide a man-made core structure which high weight specific strength and stiffness and which can be produced cost-efficiently. Anticlastic core structures as presented by Hale (1960) are equally strong in two perpendicular directions. Hale proposes various methods for making the anticlastic core structure from sheets. However, the applicability of Hale's invention seems to be limited to highly formable materials such as thermoplastics. When using conventional sheet metal, premature fracture typically limits the making of anticlastic structures (FIG. 1). It would thus be desirable to provide the geometry of forming tools which can be used to make anticlastic core structures from sheet metal. More specifically, it would be desirable to provide the geometry of forming tools which can be used for the mass production of large sandwich panels.

The procedures proposed by Hale require forces which are very large (as compared to the capacity of state-of-the-art presses) when used in conjunction with sheet metal. The procedures are thus limited to the production of small panels. It is desirable to provide a method which can be used for the production of large panels (such as needed for trucks).

### SUMMARY

An object of the present invention is to provide an optimized anticlastic sandwich core structure which can be produced in cost-effective mass production process such as progressive stamping or roll embossing.

Another object of the present invention is to provide corrugated core structures and their methods of manufacture that are suitable with applications where both costs and weight-specific mechanical performance are equally important.

Yet another object is to provide an anticlastic sandwich core structure with bounds for specific dimensions of the forming tool geometry for optimal mechanical performance of the resulting core structure.

It is still a further object of the present invention to provide a uni-directionally corrugated core structure with periodically enlarged bonding lands for enhanced shear force transmission between the core structure and the face sheets when used in sandwich construction, and for enhanced shear force transmission between two contacting core layers when using multi-core layer assemblies.

It is another object of the present invention to provide a new core structure which combines the manufacturing advantages of uni-directionally corrugated core structures with the structural advantages of anticlastic core structures.

These and other objects of the present invention are achieved in, a sandwich structure with at least one anticlastic core layer. A periodic array of adjacent truncated upward facing peaks and truncated downward facing valleys are provided with each truncated peak having a bonding land of an area A1. Each truncated valley has a bonding land of an area A2, where a ratio of A1/A2 is less than 2, a distance D between neighboring peaks and also of neighboring valleys. The corrugated layer is made from an initially flat sheet thickness of t; a first sheet layer joint to the bonding lands of the truncated peaks; and a second sheet layer joint to the bonding lands of the truncated valleys.

### BRIEF DESCRIPTION OF THE DRAWINGS

FIG. 1 illustrates one embodiment of a sandwich structure of the present invention with an anticlastic core with truncated upwards facing peaks and downwards facing valleys.

FIG. 2 illustrates one embodiment of a sandwich structure of the present invention with a flat sheet that has an initial thickness formed into a bi-directionally corrugated, anticlastic structure.

FIG. 3 illustrates a top view of one embodiment of the anticlastic structure.

FIG. 4 illustrates a three dimensional view of one embodiment of the anticlastic structure.

FIG. 5 illustrates one embodiment of an uni-directional corrugated sheet with periodically enlarged bonding lands.

FIG. 6 illustrates a side view of one embodiment of the sandwich panel of the present innovation with a anticlastic core structure and two face sheets bonded onto truncated peaks and valleys.

FIG. 7 illustrates one embodiment of a sandwich panel of the present invention with an anticlastic core structure and two face sheets bonded onto truncated peaks and valleys.

FIG. 8 illustrates the schematic of the pin pattern

FIG. 9 illustrates the schematic stamping operation from the side view (A:A)

FIG. 10 illustrates one embodiment of a tool that can be used to make the anticlastic core structure through progressive stamping.

FIG. 11 illustrates a schematic of the embossing tool (open and closed)

FIG. 12 illustrates one embodiment of a tool that can be used to make the anticlastic core structure through embossing.

FIG. 13 illustrates one embodiment of a tool that can be used to make the anticlastic core structure through embossing.

### DETAILED DESCRIPTION OF THE PREFERRED EMBODIMENTS

In one embodiment, the present invention is a sandwich core structure which combines the advantages of honeycombs and corrugated structures. In one embodiment, a method of manufacturing is provided that allows for the cost-effective making of a lightweight core structure which is equally stiff and strong in two orthogonal directions. The sandwich structure can be mass produced in an industrial environment and creates a new cost-effective lightweight material solution for a wide range of applications.

In one embodiment, the present invention provides constructed sandwich core structures, and sandwich structures, as well as their methods of manufacture. The structures of the present invention have a variety of different applications including but not limited to, mechanical impact/blast absorption, thermal management capacity, noise attenuation, fluid flow, load support and the like.

In one embodiment, a sandwich structure 10 is provided that applies to many sheet materials, including but not limited to, metals, polymers, composites, resin impregnated paper, and the like. That has an anticlastic core structure from sheet materials without fracturing the sheet material during manufacturing. The anticlastic core structure can be created through folding, stamping, progressively stamping, or roll embossing process. The wall thickness does not necessarily have to be uniform throughout the structure. When bonded together with face sheets or with other core layers by solid state, liquid phase, pressing or other methods at truncated peaks and valleys, a sandwich structure of high bending stiffness is obtained, whereas the bond transfers the shear forces from the face sheets into the core structure. These constructed solids offer a broad range of multifunctional structural use with a tremendous freedom for choosing the anticlastic architecture and whether the mechanical material properties are the same in two orthogonal directions of its plane. Multiple materials can be mixed. In one embodiment, the relative densities of the core structures are less than 10% (i.e. the porosity is higher than 90%).

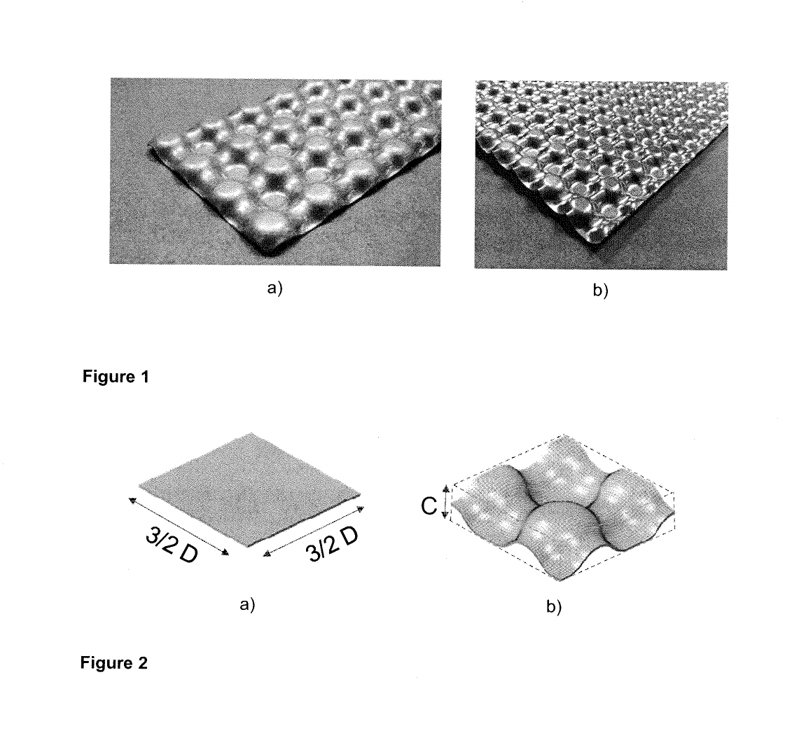

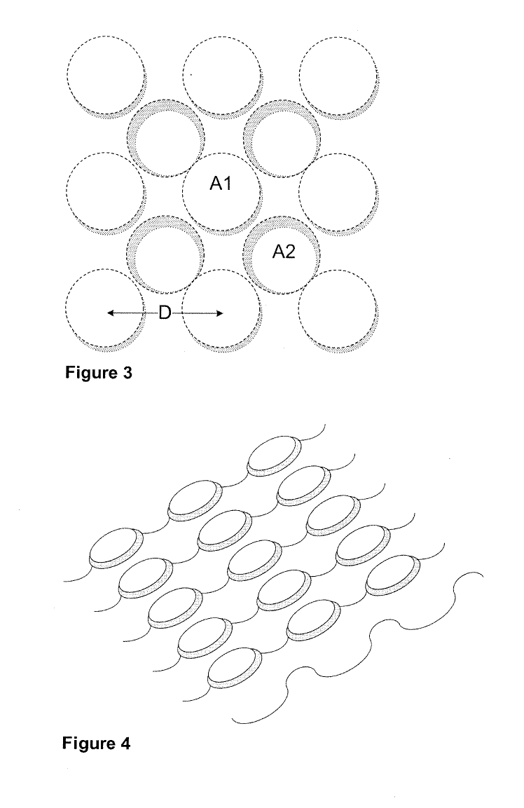

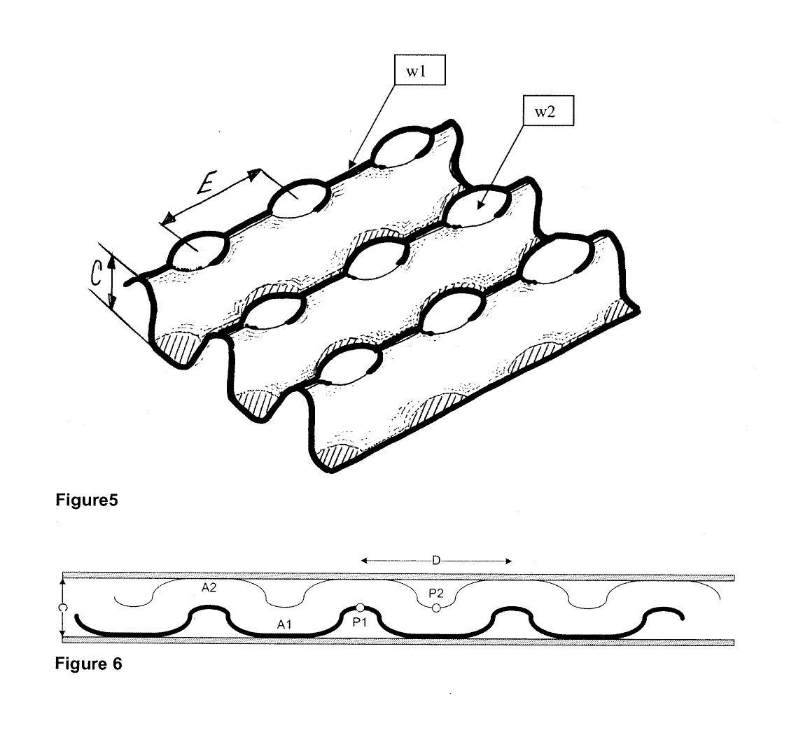

Referring to FIGS. 1-9(a) and 9(b), in one embodiment of the present invention, a sandwich structure 10 is provided that is a three layer structure. The sandwich structure 10 includes an anticlastic core structure, hereafter a corrugated layer 12, with at least one core layer (structure) made of a periodic array of adjacent truncated upward facing peaks 16 and truncated downward facing valleys 18. Each truncated peak 16 has a bonding land of an area A1. Each truncated valley 18 has a bonding land of an area A2. A ratio of A1/A2 is less than 2. A distance D is between neighboring peaks 16, and a distance D is also between neighboring valleys 18. The corrugated layer 12 is made from an initially flat sheet thickness of t.

A first sheet layer 20 is physically coupled to bonding lands 22 of the truncated peaks 16. A second sheet layer 24 is physically coupled to bonding lands 26 of the truncated valleys 18.

The bonding land area A1 is a contact area that transmits stress between a peak of the core structure and a first sheet. the bonding land area A2 is a contact area that transmits stress between a valley of the core structure and a second sheet. A ratio of A1/A2 is less than 2 and greater than 0.5.

In one embodiment, each bonding land 22 and 26 has a maximum curvature of less than 0.2/t. In one embodiment, a total corrugated core layer height after the sandwich structure 10 is formed is C, and a ratio of t/C is less than 0.10.

In one embodiment, a total corrugated core layer height after the sandwich structure 10 is formed is C, and a ratio of t/C is less than 0.10 and greater than 0.02. A ratio of A1/D² can be less than 0.7 and greater than 0.02. In one embodiment, a ratio of A2/D² is less than 0.7 and greater than 0.02. In one embodiment, a ratio of C/D is less than 1.0 and greater than 0.3.

The core structure can be made of initially flat sheet metal. In various embodiments, the metal can be flat steel sheets, flat aluminum sheets and the like.

In one embodiment, the steel sheet has a thickness greater than 0.1 mm and less than 0.6 mm. In one embodiment, the aluminum sheet has a thickness greater than 0.05 mm and less than 1.5 mm.

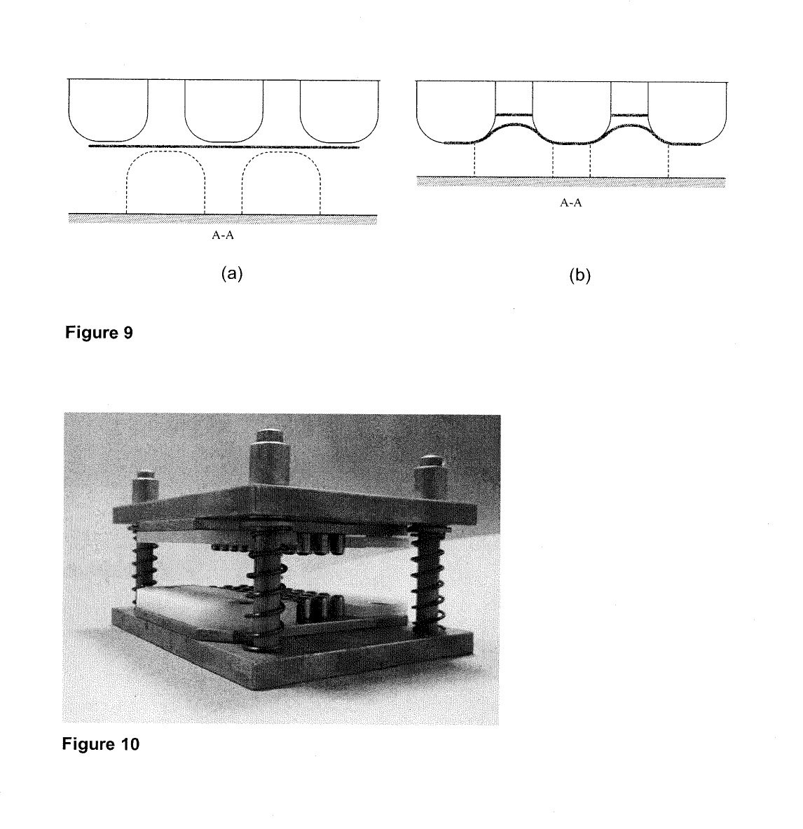

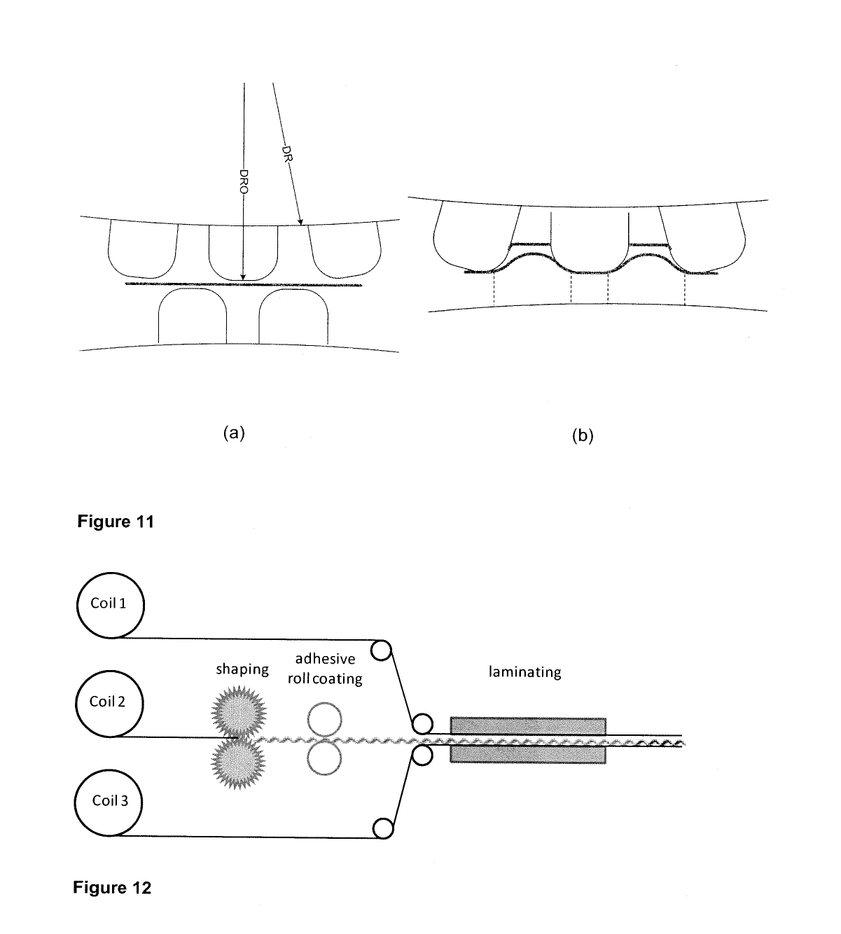

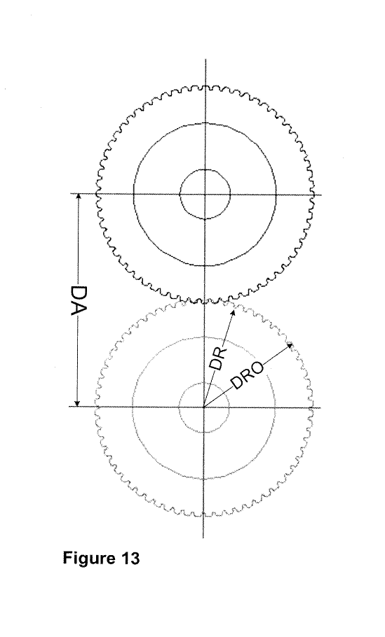

In one embodiment, the performance of the sandwich structure 10 depends on the topology of the porosity. Porosity is provided in the form of open, closed and combinations of these mixed together, as well as intermixing multiple materials to create these structures. In one embodiment, optimally designed cellular solids are provided with multifunctional possibilities. In one embodiment, many sheet materials, including but not limited to metals, polymers, composites and the like, can be shaped into cellular, anticlastic architectures comprising a periodic array of adjacent truncated upward facing peaks and truncated downward facing valleys as described above. The anticlastic core structure can be created through stamping, progressively stamping or roll embossing process, as illustrated in FIGS. 9-12. The process of manufacture can be provided to control the porosity in three dimensional space. The wall thickness does not necessarily have to be uniform throughout the structure, nor needs the initial metal sheet be imperforated. When bonded together with face sheets or with other core layers by gluing, welding, brazing or other methods at truncated peaks and valleys, a sandwich structure of high bending stiffness and strength is obtained. The bond transfers the shear forces from the face sheets into the core structure. In a mass production of the sandwich structure, adhesively bonding can be utilized due to continuous production using roll coating equipment and laminating machines. A controlled pressure can then be provided on the sandwich panel while the adhesive cures. In various embodiments and for specific applications, brazing or welding by laser, resistance, arc and the like can be used.

In one embodiment, the sandwich structure is made by methods including at least a portion disclosed in U.S. Pat. No. 5,851,342. In another embodiment, the sandwich structure is made by methods at least a portion disclosed in U.S. Pat. No. 7,997,114. It will be appreciated that other methods of manufacture can be utilized.

### Example 1

FIG. 1 shows a prototype which includes anticlastic core structures which has been made through a) stamping, b) progressive stamping. A 0.008″ thick commercial grade steel has been used as basis material. It is stamped into an anticlastic core layer of a total thickness of a) 4.3 mm and b) 5 mm.

### Example 2

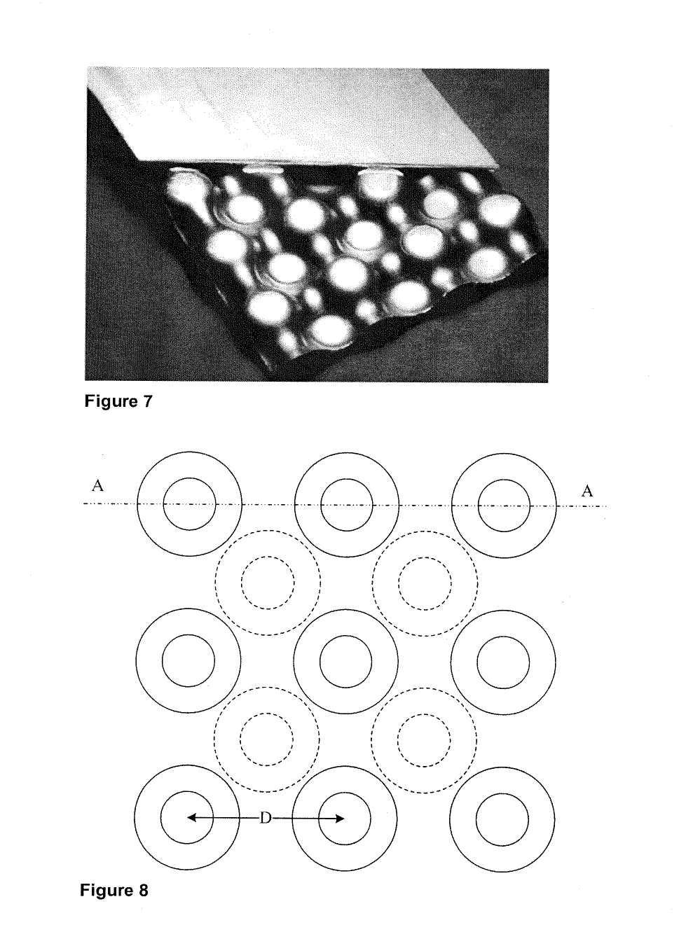

A prototype is shown in FIG. 7 where the total thickness of the sandwich panel is 6 mm.

The basis material of the core and the skins is 0.4 mm thick aluminum.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A sandwich structure, comprising:
at least one anticlastic core layer,
a periodic array of adjacent truncated upward facing peaks and truncated downward facing valleys, each truncated peak having a bonding land of an area A1,
each truncated valley having a bonding land of an area A2, wherein a ratio of A1/A2 is less than 2, a distance D between neighboring peaks, and a distance D between neighboring valleys;
wherein the corrugated layer is made from an initially flat sheet thickness of t; a first sheet layer joint to the bonding lands of the truncated peaks; and a second sheet layer joint to the bonding lands of the truncated valleys.

2. The structure of claim 1, wherein the bonding land area A1 is a contact area that transmits stress between a peak of the core structure and a first sheet.

3. The structure of claim 1, wherein the bonding land area A2 is a contact area that transmits stress between a valley of the core structure and a second sheet.

4. The structure of claim 1, wherein a ratio of A1/A2 is less than 2 and greater than 0.5.

5. The structure of claim 1, wherein each bonding land has a maximum curvature of less than 0.2/t.

6. The structure of claim 1, wherein a total corrugated core layer height after the sandwich structure is formed is C, and a ratio of t/C is less than 0.10.

7. The structure of claim 1, wherein a total corrugated core layer height after the sandwich structure is formed is C, and a ratio of t/C is less than 0.10. and greater than 0.02.

8. The structure of claim 1, wherein a ratio of A1/D² is less than 0.7 and greater than 0.02.

9. The structure of claim 1, wherein a ratio of A2/D² is less than 0.7 and greater than 0.02.

10. The structure of claim 1, wherein a ratio of C/D is less than 1.0 and greater than 0.3.

11. The structure of claim 1, wherein the core layer is made of initially flat sheet metal.

12. The structure of claim 1, wherein the core layer is made of initially flat steel sheets.

13. The structure of claim 1, wherein the core layer is made of initially flat aluminum sheets.

14. The structure of claim 12, wherein the steel sheet has a thickness greater and 0.1 mm and less than 0.6 mm.

15. The structure of claim 13, wherein the aluminum sheet has a thickness greater than 0.05 mm and less than 1.5 mm.

16. A sandwich structure comprising:
at least one core layer made of a uni-directionally corrugated sheet with bonding lands of width w1, wherein each bonding land of width w1 is periodically enlarged at a distance E to a width w2.

17. The structure of claim 16, wherein the bonding land width w1 is the width of a contact area that transmits stress between a peak of the core structure and a flat sheet.

18. The structure of claim 16, where in the ratio of w2/w1 is less than 3 and greater than 1.2.

19. A sandwich structure, comprising
at least one core layer made of a periodic array of adjacent truncated upward facing peaks and truncated downward facing valleys,
each truncated peak having a bonding land of an area A1, each truncated valley having a bonding land of an area A2, wherein a ratio of A1/A2 is less than 2, a distance D between neighboring peaks, and a distance D between neighboring valleys;
wherein the corrugated layer is made from an initially flat sheet thickness of t;
a first sheet layer joint to the bonding lands of the truncated peaks; and a second sheet layer joint to the bonding lands of the truncated valleys, having a mid-point P1 between two neighboring peaks in a first direction, having a mid-point P2 between two neighboring peaks in a second direction, a distance DP1 between the point P1 and the first sheet, a distance DP2 between the point P2 and the first sheet, the ratio of DP1/DP2 being greater than 1.0.

20. The structure of claim 19, wherein the bonding land area A1 is a contact area that transmits stress between a peak of the core structure and a first sheet.

21. The structure of claim 19, wherein the bonding land area A2 is a contact area that transmits stress between a valley of the core structure and a second sheet.

22. The structure of claim 19, wherein a ratio of A1/A2 is less than 2 and greater than 0.5.

23. The structure of claim 19, wherein each bonding land has a maximum curvature of less than 0.2/t.

24. The structure of claim 19, wherein a total corrugated core layer height after the sandwich structure is formed is C, and a ratio of t/C is less than 0.10.

25. The structure of claim 19, wherein a total corrugated core layer height after the sandwich structure is formed is C, and a ratio of t/C is less than 0.10. and greater than 0.02.

26. The structure of claim 19, wherein a ratio of A1/D² is less than 0.7 and greater than 0.02.

27. The structure of claim 19, wherein a ratio of A2/D² is less than 0.7 and greater than 0.02.

28. The structure of claim 19, wherein a ratio of C/D is less than 1.0 and greater than 0.3.

29. The structure of claim 19, wherein the core layer is made of initially flat sheet metal.

30. The structure of claim 19, wherein the core layer is made of initially flat steel sheets.

31. The structure of claim 19, wherein the core layer is made of initially flat aluminum sheets.

32. The structure of claim 12, wherein the steel sheet has a thickness greater and 0.1 mm and less than 0.6 mm.

33. The structure of claim 13, wherein the aluminum sheet has a thickness greater than 0.05 mm and less than 1.5 mm.

34. A forming tool for the forming of core structures from sheets of thickness t, comprising a periodic array of pin-like male dies, the minimum center-to-center distance D between two neighboring pins, each pin having a flat top area of diameter d, a rounded edge of minimum curvature radius r.

35. The tool of claim 34, where the ratio d/D is greater than 0.1 and less than 0.9.

36. The tool of claim 34, where the ratio of r/t is greater than 3 and less than 100.

37. The tool of claim 34, where the pins are positioned on the cylindrical surface of an embossing roll of diameter DR, with the ratio DR/D being greater than 5 and less than 40.

38. The tool of claim 37, where the pins are an integral part of a monolithic embossing roll of outer diameter DRO.

39. An embossing machine for the mass production of core layers composed of two embossing rolls of claim 37, the axes of the two embossing rolls being parallel, with an axis-to-axis distance DA, an initially flat sheet of thickness t fed into the embossing machine, the difference of DA and 2DRO being greater than 10 t and smaller than 50 t.

40. The tool of claim 34 where the pins are mounted on a top plate and on a bottom plate of a linear stamping tool with the top plate and bottom plate being parallel.
